(19) United States
(12) Patent Application Publication
(10) Pub. No.: US 2019/0239329 A1
(43) Pub. Date: Aug. 1, 2019

(54) EXTREME ULTRAVIOLET LIGHT GENERATION APPARATUS

(71) Applicant: Gigaphoton Inc., Tochigi (JP)

(72) Inventor: Tatsuya YANAGIDA, Oyama-shi (JP)

(73) Assignee: Gigaphoton Inc., Tochigi (JP)

(21) Appl. No.: 16/375,556

(22) Filed: Apr. 4, 2019

Related U.S. Application Data
(63) Continuation of application No. PCT/JP2016/082418, filed on Nov. 1, 2016.

(51) Int. Cl. H05G 2/00

(52) U.S. Cl. CPC H05G 2/008; H05G 2/003

(57) ABSTRACT

An extreme ultraviolet light generation apparatus includes: a target supply unit configured to output a target toward a predetermined region; a laser system configured to output a first laser beam to be applied to the target, a second laser beam to be applied to the target irradiated with the first laser beam, and a third laser beam to be applied to the target irradiated with the second laser beam; and a control unit configured to control the laser system such that the third laser beam is applied to the target after ions of elements constituting the target are eliminated from at least an optical path of the third laser beam.

### CROSS-REFERENCE TO RELATED APPLICATIONS

The present application is a continuation application of International Application No. PCT/JP2016/082418 filed on Nov. 1, 2016. The content of the application is incorporated herein by reference in its entirety.

### BACKGROUND

### 1. Technical Field

The present disclosure relates to an extreme ultraviolet light generation apparatus.

### 2. Related Art

Recently, miniaturization of semiconductor processes has involved increasing miniaturization of transfer patterns for use in photolithography of the semiconductor processes. In the next generation, microfabrication at 70 nm to 45 nm and further microfabrication at 32 nm or less will be required. Thus, to satisfy the requirement for the microfabrication at, for example, 32 nm or less, development of an exposure device is expected including a combination of an extreme ultraviolet light generation apparatus configured to generate an extreme ultraviolet (EUV) light having a wavelength of about 13 nm and reduced projection reflection optics.

Three types of EUV light generation apparatuses have been proposed: an LPP (Laser Produced Plasma) type apparatus using plasma generated by irradiating a target substance with a pulse laser beam, a DPP (Discharge Produced Plasma) type apparatus using plasma generated by discharge, and an SR (Synchrotron Radiation) type apparatus using synchrotron radiation light.

### LIST OF DOCUMENTS

### Patent Documents

Patent Document 1: US Published Patent Application No. 2014/077099

Patent Document 2: US Published Patent Application No. 2005/129177

### SUMMARY

An extreme ultraviolet light generation apparatus according to an aspect of the present disclosure includes: a target supply unit configured to output a target toward a predetermined region; a laser system configured to output a first laser beam to be applied to the target, a second laser beam to be applied to the target irradiated with the first laser beam, and a third laser beam to be applied to the target irradiated with the second laser beam; and a control unit configured to control the laser system such that the third laser beam is applied to the target after ions of elements constituting the target are eliminated from at least an optical path of the third laser beam.

An extreme ultraviolet light generation apparatus according to another aspect of the present disclosure includes: a target supply unit configured to output a target toward a predetermined region; a laser system configured to output a first laser beam to be applied to the target, a second laser beam to be applied to the target irradiated with the first laser beam, and a third laser beam to be applied to the target irradiated with the second laser beam; and a control unit configured to control the laser system such that the third laser beam is applied to neutral particles that remain after ions of elements constituting the target are eliminated.

An extreme ultraviolet light generation apparatus according to a further aspect of the present disclosure includes: a target supply unit configured to output a target toward a predetermined region; a laser system configured to output a first laser beam to be applied to the target, a second laser beam to be applied to the target irradiated with the first laser beam, and a third laser beam to be applied to the target irradiated with the second laser beam; and a control unit configured to control the laser system such that the third laser beam is applied to a part of the target but is not applied to ions of elements constituting the target.

### BRIEF DESCRIPTION OF THE DRAWINGS

With reference to the accompanying drawings, some embodiments of the present disclosure will be described below merely by way of example.

FIG. 1 schematically shows a configuration of an exemplary LPP type EUV light generation system.

FIG. 2 is a partial sectional view of a configuration of an EUV light generation system 11 according to a comparative example.

FIG. 3A schematically shows a primary target 271 when irradiated with a first pre-pulse laser beam P1 in the EUV light generation system 11 in FIG. 2. FIG. 3B schematically shows a secondary target 272 when irradiated with a second pre-pulse laser beam P2 in the EUV light generation system 11 in FIG. 2. FIG. 3C schematically shows a tertiary target 273 when irradiated with a main pulse laser beam M in the EUV light generation system 11 in FIG. 2. FIG. 3D shows an emission region 27e of EUV light.

FIGS. 4A to 4J show images of the tertiary target 273 captured with visible light for each elapsed time since irradiation with the second pre-pulse laser beam P2.

FIG. 5 is a graph showing changes in emission intensity obtained from the images in FIGS. 4A to 4J.

FIG. 6A schematically shows the tertiary target 273 when irradiated with the main pulse laser beam M, from which plasma 27d and ions contained in the plasma 27d are eliminated. FIG. 6B shows an emission region 27f of EUV light.

FIG. 7 is a graph showing measurement results of CE (conversion efficiency) in the EUV light generation system.

FIG. 8 schematically shows an EUV light generation system 11a according to a first embodiment of the present disclosure.

FIG. 9 schematically shows an EUV light generation system 11b according to a second embodiment of the present disclosure.

### DESCRIPTION OF EMBODIMENTS

### <Contents>

1. General description of extreme ultraviolet light generation system

1.1 Configuration

1.2 Operation

2. EUV light generation system configured to apply first to third laser beams to target

2.1 Configuration

2.1.1 Target supply unit

2.1.2 Target sensor and light-emitting unit

2.1.3 Laser system

2.1.4 Laser beam traveling direction control unit

2.1.5 Focusing optics and EUV light focusing mirror

2.2 Operation

2.2.1 Output of target

2.2.2 Detection of target

2.2.3 Output of pulse laser beam

2.2.4 Transmission of pulse laser beam

2.2.5 Focusing of pulse laser beam

2.3 Changes in target irradiated with pulse laser beam

2.3.1 Primary target 271

2.3.2 Secondary target 272

2.3.3 Tertiary target 273

2.4 Problem

2.5 Behavior of tertiary target 273

2.6 Irradiation with main pulse after elimination of

ions

3. EUV light generation system including timer for measuring time after irradiation with second pre-pulse laser beam P2

3.1 Example of timer holding required time

3.2 Example of memory holding required time

3.3 Others

4. EUV light generation system including ion detector

4.1 Example of continuous monitoring of presence of ions

4.2 Example of determination of presence of ions at specific timing

4.3 Others

### 5. Supplementation

Now, with reference to the drawings, embodiments of the present disclosure will be described in detail. The embodiments described below illustrate some examples of the present disclosure, and do not limit contents of the present disclosure. Also, all configurations and operations described in the embodiments are not necessarily essential as configurations and operations of the present disclosure. Like components are denoted by like reference numerals, and overlapping descriptions are omitted.

### 1. General Description of Extreme Ultraviolet Light Generation System

1.1 Configuration

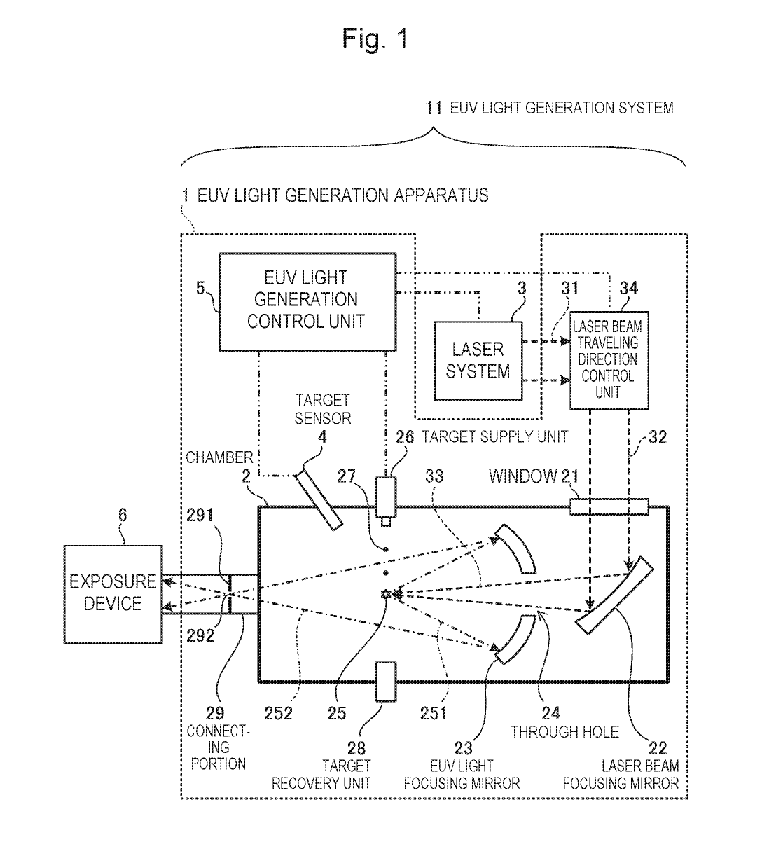

FIG. 1 schematically shows a configuration of an exemplary LPP type EUV light generation system. An EUV light generation apparatus 1 is used together with at least one laser system 3. In this application, a system including the EUV light generation apparatus 1 and the laser system 3 is referred to as an EUV light generation system 11. As shown in FIG. 1 and described below in detail, the EUV light generation apparatus 1 includes a chamber 2 and a target supply unit 26. The chamber 2 is configured to be sealable. The target supply unit 26 is mounted, for example, so as to extend through a wall of the chamber 2. A material of a target substance output from the target supply unit 26 may include tin, terbium, gadolinium, lithium, xenon, or any combinations of two or more of them, but not limited to them.

The wall of the chamber 2 has at least one through hole. A window 21 is provided in the through hole. A pulse laser beam 32 output from the laser system 3 passes through the window 21. In the chamber 2, an EUV light focusing mirror 23 having, for example, a spheroidal reflective surface is arranged. The EUV light focusing mirror 23 has first and second focuses. On a surface of the EUV light focusing mirror 23, a multilayer reflective film including, for example, alternately stacked molybdenum and silicon is formed. The EUV light focusing mirror 23 is arranged such that, for example, its first focus is located in a plasma generation region 25 and its second focus is located in an intermediate focal (IF) point 292. A through hole 24 is provided in a center of the EUV light focusing mirror 23. A pulse laser beam 33 passes through the through hole 24.

The EUV light generation apparatus 1 includes an EUV light generation control unit 5, a target sensor 4, or the like. The target sensor 4 has an imaging function, and is configured to detect presence, a path, a position, a speed, or the like of the target 27.

The EUV light generation apparatus 1 includes a connecting portion 29 configured to provide communication between an interior of the chamber 2 and an interior of an exposure device 6. In the connecting portion 29, a wall 291 having an aperture is provided. The wall 291 is arranged such that the aperture is located in a second focal position of the EUV light focusing mirror 23.

Further, the EUV light generation apparatus 1 includes a laser beam traveling direction control unit 34, a laser beam focusing mirror 22, a target recovery unit 28 for recovering the target 27, or the like. The laser beam traveling direction control unit 34 includes an optical element for defining a traveling direction of a laser beam, and an actuator for adjusting a position, an attitude, or the like of the optical element.

1.2 Operation

With reference to FIG. 1, a pulse laser beam 31 output from the laser system 3 passes through the laser beam traveling direction control unit 34 and passes through the window 21 as the pulse laser beam 32, which enters the chamber 2. The pulse laser beam 32 travels along at least one laser beam path in the chamber 2, is reflected by the laser beam focusing mirror 22, and applied as the pulse laser beam 33 to at least one target 27.

The target supply unit 26 outputs the target 27 toward the plasma generation region 25 in the chamber 2. The target 27 is irradiated with at least one pulse contained in the pulse laser beam 33. The target 27 irradiated with the pulse laser beam is turned into plasma, and radiation light 251 is radiated from the plasma. The EUV light focusing mirror 23 reflects EUV light contained in the radiation light 251 with higher reflectance than light in a different wavelength range. Reflected light 252 containing the EUV light reflected by the EUV light focusing mirror 23 is focused at the intermediate focal point 292 and output to the exposure device 6. One target 27 may be irradiated with a plurality of pulses contained in the pulse laser beam 33.

The EUV light generation control unit 5 collectively controls the entire EUV light generation system 11. The EUV light generation control unit 5 processes image data or the like of the target 27 captured by the target sensor 4. Also, the EUV light generation control unit 5 controls, for example, output timing of the target 27, an output direction of the target 27, or the like. Further, the EUV light generation control unit 5 controls, for example, oscillation timing of the laser system 3, a traveling direction of the pulse laser beam 32, a focusing position of the pulse laser beam 33, or the like. These various controls are mere examples, and other controls may be added as required.

### 2. EUV Light Generation System Configured to Apply First to Third Laser Beams to Target

2.1 Configuration

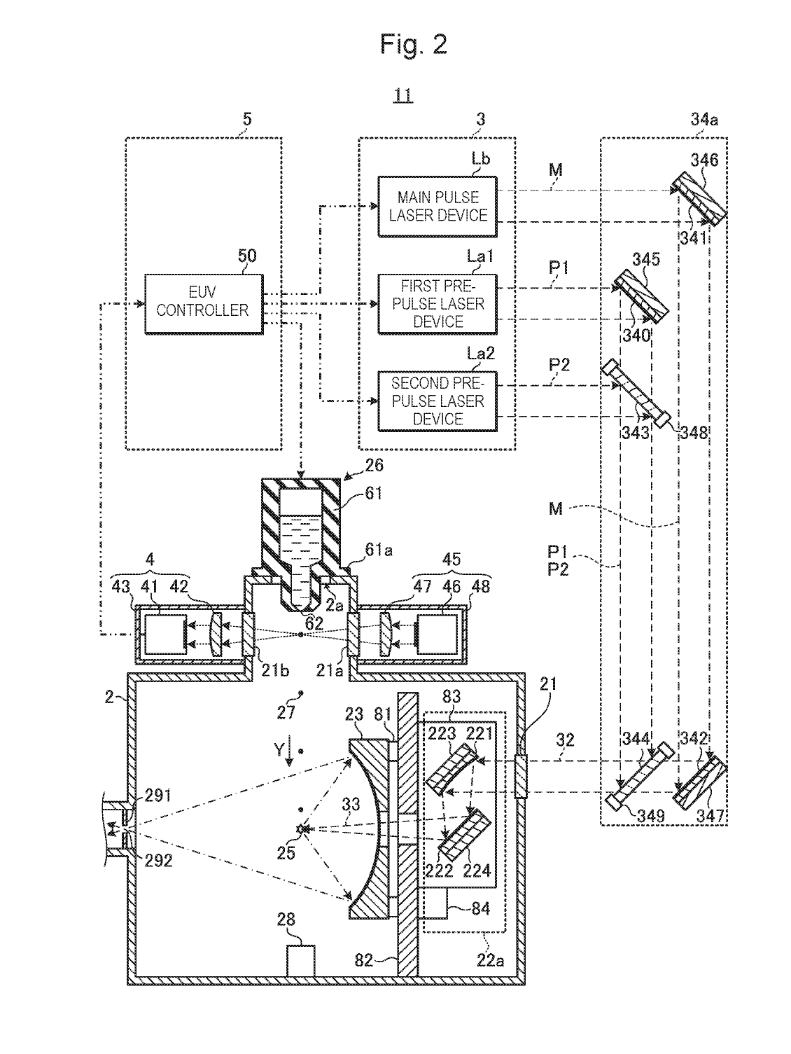

FIG. 2 is a partial sectional view of a configuration of an EUV light generation system 11 according to a comparative example. As shown in FIG. 2, in a chamber 2, focusing optics 22a, an EUV light focusing mirror 23, a target recovery unit 28, an EUV light focusing mirror holder 81, and plates 82 and 83 are provided. To the chamber 2, a target supply unit 26, a target sensor 4, and a light-emitting unit 45 are mounted.

Outside the chamber 2, a laser system 3, a laser beam traveling direction control unit 34a, and an EUV light generation control unit 5 are provided. The EUV light generation control unit 5 includes an EUV controller 50.

2.1.1 Target Supply Unit

The target supply unit 26 has a reservoir 61. A part of the reservoir 61 extends through a through hole 2a formed in a wall surface of the chamber 2, and a front end of the reservoir 61 is located in the chamber 2. The front end of the reservoir 61 has an opening 62. Near the opening 62 in the front end of the reservoir 61, a vibrating device (not shown) is arranged. The reservoir 61 stores a target substance therein. A flange portion 61a of the reservoir 61 is closely secured to the wall surface of the chamber 2 around the through hole 2a.

2.1.2 Target Sensor and Light-Emitting Unit

The target sensor 4 and the light-emitting unit 45 are arranged on opposite sides with a trajectory of a target 27 therebetween. Windows 21a and 21b are mounted to the chamber 2. The window 21a is located between the light-emitting unit 45 and the trajectory of the target 27. The window 21b is located between the trajectory of the target 27 and the target sensor 4.

The target sensor 4 includes an optical sensor 41, focusing optics 42, and a casing 43. The casing 43 is secured to an outside of the chamber 2. The optical sensor 41 and the focusing optics 42 are secured in the casing 43. The light-emitting unit 45 includes a light source 46, focusing optics 47, and a casing 48. The casing 48 is secured to the outside of the chamber 2. The light source 46 and the focusing optics 47 are secured in the casing 48.

2.1.3 Laser System

The laser system 3 includes a first pre-pulse laser device La1, a second pre-pulse laser device La2, and a main pulse laser device Lb. The first pre-pulse laser device La1 and the second pre-pulse laser device La2 are constituted by, for example, YAG laser devices. Alternatively, the first pre-pulse laser device La1 and the second pre-pulse laser device La2 are constituted by laser devices using Nd:YVO₄. The main pulse laser device Lb is constituted by a CO₂ laser device. These laser devices each include a laser oscillator and a laser amplifier as required. The YAG laser device uses a YAG crystal as a laser medium in one or both of the laser oscillator and the laser amplifier. The CO₂ laser device uses a CO₂ gas as a laser medium in one or both of the laser oscillator and the laser amplifier.

2.1.4 Laser Beam Traveling Direction Control Unit

The laser beam traveling direction control unit 34a includes high reflection mirrors 340, 341 and 342, and beam combiners 343 and 344. The high reflection mirror 340 is supported by a holder 345. The high reflection mirror 341 is supported by a holder 346. The high reflection mirror 342 is supported by a holder 347.

The beam combiner 343 is supported by a holder 348. The beam combiner 343 is constituted by a polarizer.

The beam combiner 344 is supported by a holder 349. The beam combiner 344 is constituted by a dichroic mirror.

2.1.5 Focusing Optics and EUV Light Focusing Mirror

The plate 82 is secured to the chamber 2. The plate 82 supports the plate 83 and a position adjustment mechanism 84. The focusing optics 22a includes an off axis paraboloid mirror 221 and a plane mirror 222. The off axis paraboloid mirror 221 is supported by a holder 223. The plane mirror 222 is supported by a holder 224. The holders 223 and 224 are secured to the plate 83.

The EUV light focusing mirror 23 is secured to the plate 82 via the EUV light focusing mirror holder 81.

2.2 Operation

2.2.1 Output of Target

The EUV controller 50 included in the EUV light generation control unit 5 outputs a control signal to the target supply unit 26.

In the target supply unit 26, the target substance in the reservoir 61 is maintained at a temperature equal to or higher than a melting point of the target substance by a heater (not shown) provided in the reservoir 61. The target substance in the reservoir 61 is pressurized by an inert gas supplied into the reservoir 61.

The target substance pressurized by the inert gas is output as a jet through the opening 62. The vibrating device vibrates the reservoir 61. The vibration separates the jet of the target substance into a plurality of droplets. The droplets constitute the target 27. The target 27 moves in an arrow Y direction along the trajectory from the target supply unit 26 to the plasma generation region 25.

The target recovery unit 28 recovers the target 27 having passed through the plasma generation region 25.

2.2.2 Detection of Target

The light-emitting unit 45 focuses light output from the light source 46 substantially on the trajectory of the target 27 between the target supply unit 26 and the plasma generation region 25. The target 27 passes through a light focusing position by the light-emitting unit 45. At this time, the target sensor 4 detects a change in intensity of the light passing through the trajectory of the target 27 and therearound. The target sensor 4 outputs a target detection signal based on the change in the light intensity. The EUV controller 50 receives the target detection signal.

2.2.3 Output of Pulse Laser Beam

The EUV controller 50 outputs a first trigger signal to the first pre-pulse laser device La1 based on the target detection signal. The first trigger signal is output when a first delay time has elapsed with respect to a receiving timing of the target detection signal. The first pre-pulse laser device La1 outputs a first pre-pulse laser beam P1 according to the first trigger signal. The first pre-pulse laser beam P1 corresponds to a first laser beam in the present disclosure.

The EUV controller 50 outputs a second trigger signal to the second pre-pulse laser device La2. The second trigger signal is output when a second delay time longer than the first delay time has elapsed with respect to the receiving timing of the target detection signal. The second pre-pulse laser device La2 outputs a second pre-pulse laser beam P2 according to the second trigger signal. The second pre-pulse laser beam P2 corresponds to a second laser beam in the present disclosure.

The EUV controller 50 outputs a third trigger signal to the main pulse laser device Lb. The third trigger signal is output when a third delay time longer than the second delay time has elapsed with respect to the receiving timing of the target detection signal. The main pulse laser device Lb outputs a main pulse laser beam M according to the third trigger signal. The main pulse laser beam M corresponds to a third laser beam in the present disclosure.

As such, the laser system 3 outputs the first pre-pulse laser beam P1, the second pre-pulse laser beam P2, and the main pulse laser beam M in this order. The first pre-pulse laser beam P1 preferably has a pulse time width of picosecond order. The picosecond order refers to 1 ps or more and less than 1 ns. A pulse time width of the second pre-pulse laser beam P2 is preferably smaller than a pulse time width of the main pulse laser beam M. A delay circuit (not shown) may measure the first to third delay times, and output the first to third trigger signals to the respective laser devices.

2.2.4 Transmission of Pulse Laser Beam

The high reflection mirror 340 included in the laser beam traveling direction control unit 34a is arranged on an optical path of the first pre-pulse laser beam P1 output by the first pre-pulse laser device La1. The high reflection mirror 340 reflects the first pre-pulse laser beam P1 with high reflectance.

The beam combiner 343 is arranged at a position where the optical path of the first pre-pulse laser beam P1 reflected by the high reflection mirror 340 crosses an optical path of the second pre-pulse laser beam P2 output by the second pre-pulse laser device La1.

The first pre-pulse laser beam P1 is a linearly polarized beam with a polarization direction parallel to the plane of FIG. 2. The second pre-pulse laser beam P2 is a linearly polarized beam with a polarization direction perpendicular to the plane of FIG. 2. The first pre-pulse laser beam P1 enters the beam combiner 343 from an upper side in FIG. 2. The second pre-pulse laser beam P2 enters the beam combiner 343 from a left side in FIG. 2. The polarizer that constitutes the beam combiner 343 transmits the first pre-pulse laser beam P1 with high transmittance, and reflects the second pre-pulse laser beam P2 with high reflectance. Thus, the beam combiner 343 guides the first pre-pulse laser beam P1 and the second pre-pulse laser beam P2 to the beam combiner 344 with their optical path axes being substantially matched.

The high reflection mirrors 341 and 342 are arranged on an optical path of the main pulse laser beam M output by the main pulse laser device Lb. The high reflection mirrors 341 and 342 successively reflect the main pulse laser beam M with high reflectance.

The beam combiner 344 is arranged at a position where the optical paths of the first pre-pulse laser beam P1 and the second pre-pulse laser beam P2 cross the optical path of the main pulse laser beam M reflected by the high reflection mirror 342.

The first pre-pulse laser beam P1 and the second pre-pulse laser beam P2 contain a first wavelength component. The main pulse laser beam M contains a second wavelength component different from the first wavelength component. The first pre-pulse laser beam P1 and the second pre-pulse laser beam P2 enter the beam combiner 344 from the upper side in FIG. 2. The main pulse laser beam M enters the beam combiner 344 from a right side in FIG. 2. The dichroic mirror that constitutes the beam combiner 344 reflects the first pre-pulse laser beam P1 and the second pre-pulse laser beam P2 containing the first wavelength component with high reflectance, and transmits the main pulse laser beam M containing the second wavelength component with high transmittance. Thus, the beam combiner 344 guides the first pre-pulse laser beam P1, the second pre-pulse laser beam P2, and the main pulse laser beam M as a pulse laser beam 32 to the focusing optics 22a with their optical path axes being substantially matched.

If the first pre-pulse laser beam P1 and the second pre-pulse laser beam P2 have different wavelength components, the beam combiner 343 may be also constituted by a dichroic mirror.

2.2.5 Focusing of Pulse Laser Beam

The off axis paraboloid mirror 221 included in the focusing optics 22a is arranged on an optical path of the pulse laser beam 32. The off axis paraboloid mirror 221 reflects the pulse laser beam 32 toward the plane mirror 222. The plane mirror 222 reflects the pulse laser beam 32 reflected by the off axis paraboloid mirror 221 as a pulse laser beam 33. The pulse laser beam 33 is focused according to a shape of a reflective surface of the off axis paraboloid mirror 221.

The position adjustment mechanism 84 adjusts a position of the plate 83 relative to the plate 82. The position adjustment mechanism 84 is controlled by a control signal output from the EUV controller 50. The position of the plate 83 is adjusted to adjust positions of the off axis paraboloid mirror 221 and the plane mirror 222. The positions of the off axis paraboloid mirror 221 and the plane mirror 222 are adjusted such that the pulse laser beam 33 reflected by the mirrors is focused on the plasma generation region 25.

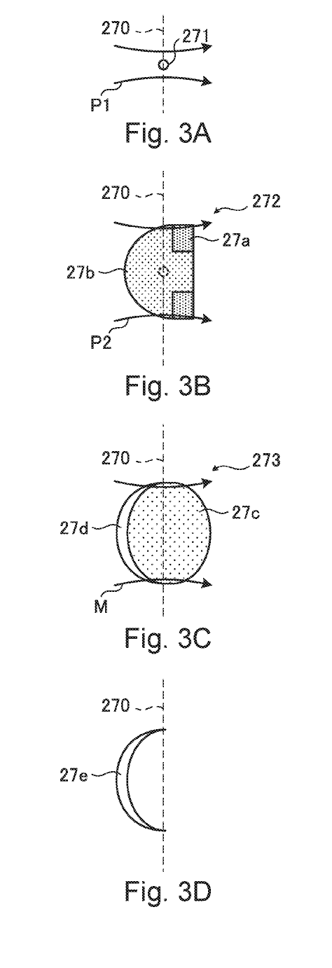

At or near the plasma generation region 25, one target 27 is irradiated with the first pre-pulse laser beam P1, the second pre-pulse laser beam P2, and the main pulse laser beam M in this order. A primary target 271, a secondary target 272, and a tertiary target 273 described later with reference to FIGS. 3A to 3C are herein collectively referred to as “target 27”.

When the target 27 is irradiated with the first pre-pulse laser beam P1, the second pre-pulse laser beam P2, and the main pulse laser beam M, the target 27 is turned into plasma, and EUV light is generated from the plasma. The present disclosure is not limited to this, but the target may be irradiated with a fourth laser beam between the first pre-pulse laser beam P1 and the second pre-pulse laser beam P2. The target may be irradiated with a fifth laser beam between the second pre-pulse laser beam P2 and the main pulse laser beam M.

2.3 Changes in Target Irradiated with Pulse Laser Beam

FIGS. 3A, 3B, and 3C schematically show the target when irradiated with the first pre-pulse laser beam P1, the second pre-pulse laser beam P2, and the main pulse laser beam M in the EUV light generation system 11 in FIG. 2, respectively. A density of dots in FIGS. 3B and 3C corresponds to a density of the target substance. FIG. 3C shows a case where the main pulse laser beam M is applied after application of the second pre-pulse laser beam P2 and before elimination of ions of the target substance.

In FIGS. 3A to 3C, the first pre-pulse laser beam P1, the second pre-pulse laser beam P2, and the main pulse laser beam M are applied from a left side to a right side. The dashed line 270 shows the trajectory of the target 27 and its extension.

2.3.1 Primary Target 271

FIG. 3A shows the primary target 271. The target 27 after output from the target supply unit 26 and before irradiated with the first pre-pulse laser beam P1 is referred to as the primary target 271. The primary target 271 is in the form of droplets. When the primary target reaches the plasma generation region 25, the primary target 271 is irradiated with the first pre-pulse laser beam P1.

2.3.2 Secondary Target 272

When the primary target 271 is irradiated with the first pre-pulse laser beam P1, the primary target 271 is broken into a plurality of fine particles and diffused.

FIG. 3B shows the secondary target 272. The target 27 after irradiated with the first pre-pulse laser beam P1 and before irradiated with the second pre-pulse laser beam P2 is referred to as the secondary target 272. The secondary target 272 contains a plurality of fine particles.

As shown in FIG. 3B, the secondary target 272 generated by application of the first pre-pulse laser beam P1 having the pulse time width of picosecond order has an annular portion 27a and a dome portion 27b. The annular portion 27a has a relatively high density of target substance with the target substance being diffused on a downstream side of the optical path of the first pre-pulse laser beam P1. The dome portion 27b has a relatively low density of target substance with the target substance being diffused on an upstream side of the optical path of the first pre-pulse laser beam P1. The upstream side of the optical path refers to a direction approaching a light source along the optical path, and the downstream side of the optical path refers to a direction away from the light source along the optical path. The secondary target 272 is irradiated with the second pre-pulse laser beam P2.

2.3.3 Tertiary Target 273

When the secondary target 272 is irradiated with the second pre-pulse laser beam P2, a part of the secondary target 272 is broken into a plurality of finer particles. Another part of the secondary target 272 is sometimes turned into vapor. A further different part of the secondary target 272 is sometimes turned into plasma.

FIG. 3C shows the tertiary target 273. The target 27 after irradiated with the second pre-pulse laser beam P2 and before irradiated with the main pulse laser beam M is referred to as the tertiary target 273. The tertiary target 273 contains a plurality of fine particles. The tertiary target 273 sometimes contains vapor. A region where the plurality of fine particles and vapor are dispersed is referred to as a dispersion region 27c. The target substance distributed at high density in the annular portion 27a in the secondary target 272 is diffused by irradiation with the second pre-pulse laser beam P2 to prevent unbalanced density of the target substance.

The tertiary target 273 sometimes further contains plasma 27d. The plasma 27d contains ions of the target substance. The plasma 27d is located on the upstream side of the optical path of the second pre-pulse laser beam P2 in the tertiary target 273. The plasma 27d may be generated by a part of the dome portion 27b of the secondary target 272 absorbing most of energy of the second pre-pulse laser beam P2. The tertiary target 273 is irradiated with the main pulse laser beam M.

When the tertiary target 273 is irradiated with the main pulse laser beam M, at least a part of the tertiary target 273 is turned into plasma, and EUV light is generated from the plasma.

2.4 Problem

The dispersion region 27c with the plurality of fine particles and the vapor in the tertiary target 273 has a low density of target substance. Thus, the plurality of fine particles and the vapor contained in the tertiary target 273 tend to absorb energy of the main pulse laser beam M. If the tertiary target 273 efficiently absorbs the energy of the main pulse laser beam M, the tertiary target 273 is efficiently turned into plasma.

However, the ions contained in the plasma 27d of the tertiary target 273 sometimes reflect or absorb the main pulse laser beam M. For example, it is reported that if the ions are irradiated with a CO₂ laser beam, components of the laser beam reflected or absorbed by the ions increase at an ion density of higher than 10¹⁶ atoms/cm³. Components of the energy of the main pulse laser beam M reflected or absorbed by the ions contained in the plasma 27d sometimes do not reach the dispersion region 27c.

FIG. 3D shows an emission region 27e of EUV light. When a part of the energy of the main pulse laser beam M is absorbed by the ions contained in the plasma 27d, the plasma 27d is heated to a high temperature. However, parts of the plurality of fine particles and the vapor present in the dispersion region 27c may not be turned into plasma or contribute to generation of the EUV light. The emission region 27e of the EUV light may be narrow similarly to the region of the plasma 27d in FIG. 3C. In this case, conversion efficiency of the energy of the laser beam into the energy of the EUV light may be low. The conversion efficiency is referred to as CE.

2.5 Behavior of Tertiary Target 273

The present inventor observed behavior of the plasma 27d contained in the tertiary target 273.

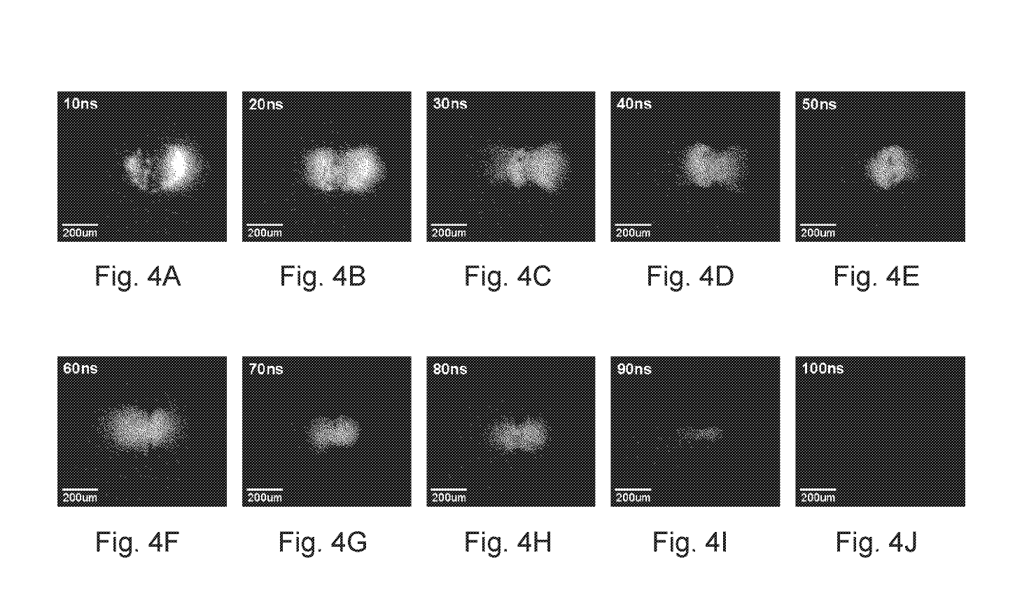

FIGS. 4A to 4J show images of the tertiary target 273 captured with visible light for each elapsed time since the irradiation with the second pre-pulse laser beam P2. The first image in FIG. 4A is an image taken when 10 ns has elapsed since the irradiation with the second pre-pulse laser beam P2. The second image and thereafter in FIGS. 4B to 4J are images taken every time 10 ns has further elapsed. The tenth image in FIG. 4J is an image taken when 100 ns has elapsed since the irradiation with the second pre-pulse laser beam P2. In FIGS. 4A to 4J, the second pre-pulse laser beam P2 is applied from a right side to a left side unlike the traveling direction of the second pre-pulse laser beam P2 in FIG. 3B. The centers in FIGS. 4A to 4J substantially correspond to the center of the plasma generation region 25.

The images in FIGS. 4A to 4J were captured without a light source such as the light source 46 described with reference to FIG. 2 being turned on. FIGS. 4A to 4J show observed visible light components of the light emitted from the plasma 27d. Without such light being observed, there may be substantially no target substance in an excited state for emitting light and substantially no ions of the target substance.

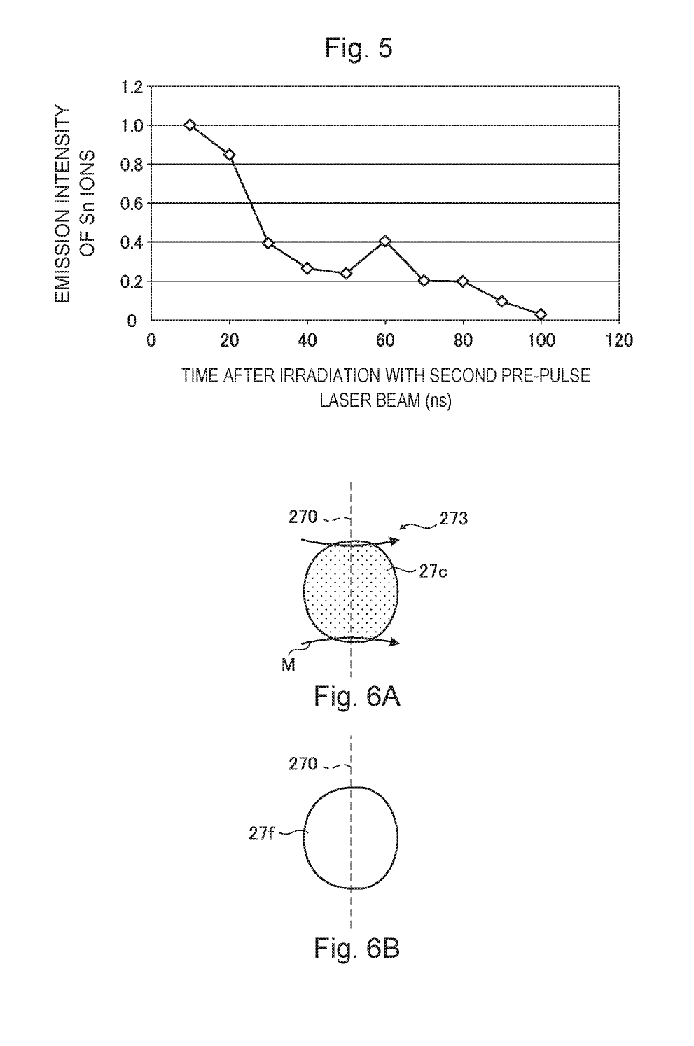

FIG. 5 is a graph showing changes in emission intensity obtained from the images in FIGS. 4A to 4J. The emission intensity in FIG. 5 is calculated using an integrated value of brightness of the second pre-pulse laser beam P2 along a beam central axis in the images, and is a relative value with respect to a value of 1 when 10 ns has elapsed since the irradiation with the second pre-pulse laser beam P2. The beam central axis of the second pre-pulse laser beam P2 is a horizontal line passing through substantially the center of FIGS. 4A to 4J.

As shown in FIG. 4A, when 10 ns has elapsed since the irradiation with the second pre-pulse laser beam P2, a substantially crescent intense emission region is present on the upstream side of the optical path of the second pre-pulse laser beam P2. The shape of the emission region may correspond to the shape of the plasma 27d in FIG. 3C.

As shown in FIGS. 4B and 5, when 20 ns has elapsed since the irradiation with the second pre-pulse laser beam P2, the emission intensity starts to decrease and the emission region is diffused. This may represent neutralization of a part of the ions to reduce the number of the ions and diffused distribution regions of the ions.

As shown in FIGS. 4C to 41 and 5, with increasing elapsed time since the irradiation with the second pre-pulse laser beam P2, the emission intensity further decreases and the emission region also decreases. As shown in FIGS. 4J and 5, when 100 ns has elapsed since the irradiation with the second pre-pulse laser beam P2, the emission intensity decreases substantially to a detection limit value. The ions of the target substance may be no longer present when 100 ns has elapsed since the irradiation with the second pre-pulse laser beam P2.

The results in FIGS. 4A to 4J and 5 have shown that after a certain time has elapsed since the irradiation with the second pre-pulse laser beam P2, the plasma 27d in FIG. 3C and the ions contained in the plasma 27d are eliminated.

2.6 Irradiation with Main Pulse after Elimination of Ions

FIG. 6A schematically shows the tertiary target 273 when irradiated with the main pulse laser beam M, from which the plasma 27d and the ions contained in the plasma 27d are eliminated. If the plasma 27d and the ions contained in the plasma 27d are eliminated after the irradiation with the second pre-pulse laser beam P2, a plurality of fine particles and vapor may remain in the dispersion region 27c. Such a plurality of fine particles and vapor are referred to as neutral particles to distinguish them from the ions.

In the tertiary target 273 in FIG. 6A, the energy of the main pulse laser beam M may reach substantially the entire dispersion region 27c with the plurality of fine particles and the vapor.

FIG. 6B shows an emission region 27f of EUV light. When the energy of the main pulse laser beam M reaches substantially the entire dispersion region 27c, most of the tertiary target 273 is expected to be turned into plasma. The emission region 27f of the EUV light is larger than the emission region 27e of the EUV light when the main pulse laser beam M is applied to the plasma 27d and the ions contained in the plasma 27d. This may improve the CE.

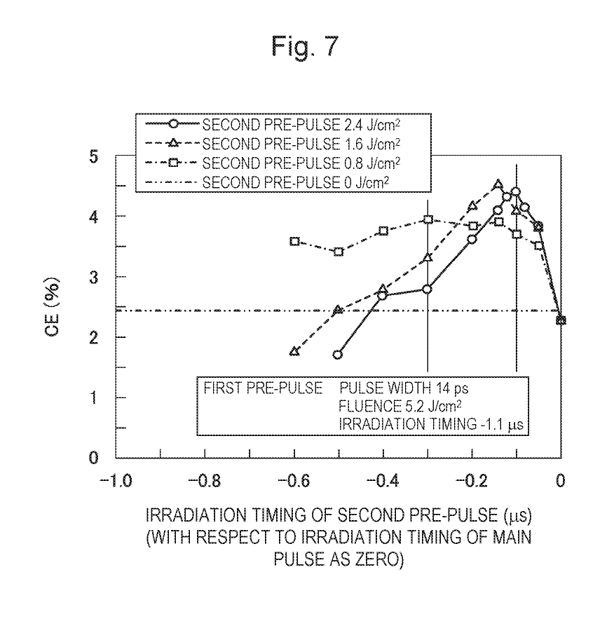

FIG. 7 is a graph showing measurement results of the CE in the EUV light generation system. In FIG. 7, the horizontal axis represents irradiation timing of the second pre-pulse laser beam P2, and the vertical axis represents the CE. In FIG. 7, irradiation timing of the main pulse laser beam M is denoted as zero, and the irradiation timing of the second pre-pulse laser beam P2 precedes the irradiation timing of the main pulse laser beam M.

The CE was measured under the following conditions.

Liquid tin was used as the target 27. A diameter of the target 27 was 21 μm to 22 μm.

As the first pre-pulse laser beam P1, a pulse laser beam having a wavelength of 1.06 μm was used. The pulse width of the first pre-pulse laser beam P1 with a full width at half maximum was 14 ps. A focus diameter of the first pre-pulse laser beam P1 was 70 μm when represented by a diameter of a portion having light intensity of 1/e² or higher of peak intensity at the irradiation position of the target.

A fluence of the first pre-pulse laser beam P1 was 5.2 J/cm². Irradiation timing of the first pre-pulse laser beam P1 was taken −1.1 μs back from the irradiation timing of the main pulse laser beam M as zero.

As the second pre-pulse laser beam P2, a pulse laser beam having a wavelength of 1.06 μm was used. The pulse width of the second pre-pulse laser beam P2 with a full width at half maximum was 5 ns. A focus diameter of the second pre-pulse laser beam P2 was 400 μm when represented by a diameter of a portion having light intensity of 1/e² or higher of peak intensity at the irradiation position of the target.

Four fluences of the second pre-pulse laser beam P2 of 2.4 J/cm², 1.6 J/cm², 0.8 J/cm², and 0 J/cm² were set. The case with 0 J/cm² corresponds to no second pre-pulse laser beam P2 being applied. For each set value of the fluence of the second pre-pulse laser beam P2, the CE was measured while the irradiation timing of the second pre-pulse laser beam P2 being changed between −0.6 μs to 0 μs.

As the main pulse laser beam M, a pulse laser beam having a wavelength 10.6 μm was used. The pulse width of the main pulse laser beam M with a full width at half maximum was 15 ns. A focus diameter of the main pulse laser beam M was 300 μm when represented by a diameter of a portion having light intensity of 1/e² or higher of peak intensity at the irradiation position of the target.

The results in FIG. 7 show the following: When the fluence of the second pre-pulse laser beam P2 was 2.4 J/cm², the CE represented a maximum value at the irradiation timing of −0.1 μs of the second pre-pulse laser beam P2.

When the fluence of the second pre-pulse laser beam P2 was 1.6 J/cm², the CE represented a maximum value at the irradiation timing of −0.14 μs of the second pre-pulse laser beam P2.

When the fluence of the second pre-pulse laser beam P2 was 0.8 J/cm², the CE represented a maximum value at the irradiation timing of −0.3 μs of the second pre-pulse laser beam P2.

The results in FIG. 7 show that high CE can be obtained by the target being irradiated with the main pulse laser beam M at the elapsed time of 100 ns to 300 ns since the irradiation with the second pre-pulse laser beam P2.

From the results in FIGS. 4A to 4J and 5 and the results in FIG. 7 in combination, high CE can be obtained by the target being irradiated with the main pulse laser beam M after the elimination of the ions. From the above, it is supposed that within the range of the elapsed time of 100 ns to 300 ns since the irradiation with the second pre-pulse laser beam P2, high CE is obtained because the ion density of the target irradiated with the main pulse laser beam M is 10¹⁶ atoms/cm³ or lower. However, after 300 ns has elapsed since the irradiation with the second pre-pulse laser beam P2, the density of the tertiary target 273 may be out of an optimum range.

In the embodiment described below, the target is irradiated with the main pulse laser beam M after the ions generated by the irradiation with the second pre-pulse laser beam P2 are eliminated.

This allows the target to efficiently absorb the energy of the main pulse laser beam to improve the CE. “The ions being eliminated” may refer to the ion density on the optical path of the main pulse laser beam M being 10¹⁶ atoms/cm³ or lower.

3. EUV Light Generation System Including Timer for Measuring Time after Irradiation with Second Pre-Pulse Laser Beam P2

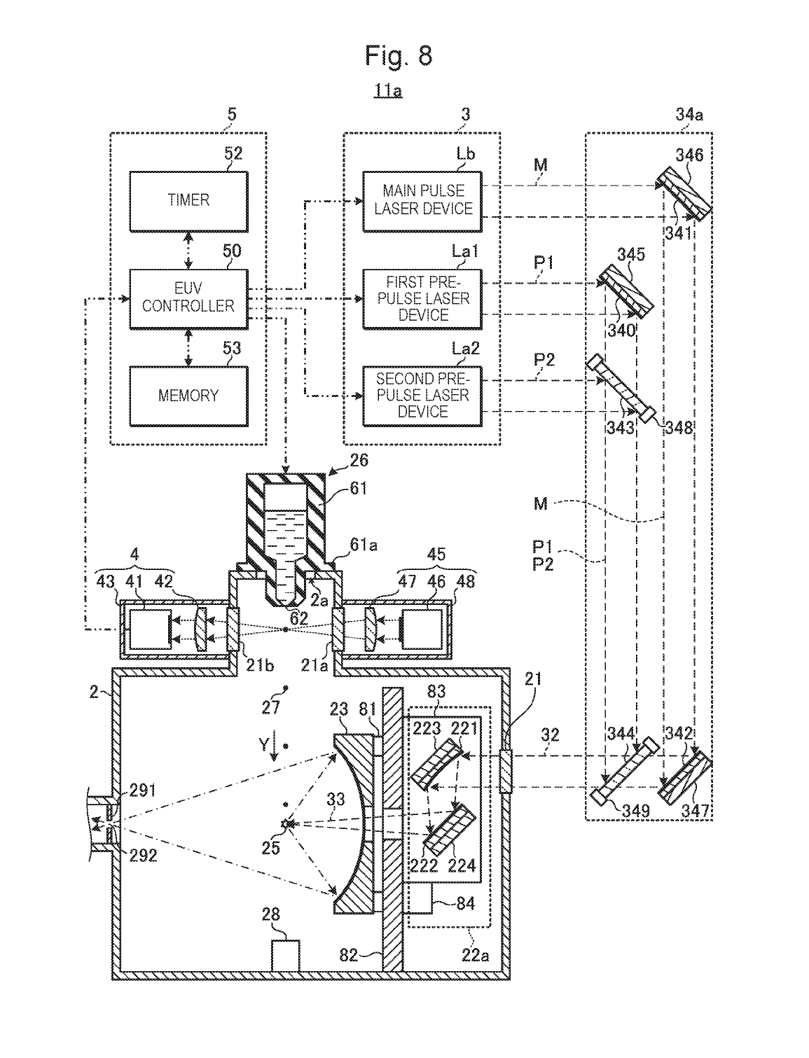

FIG. 8 schematically shows an EUV light generation system 11a according to a first embodiment of the present disclosure. In the first embodiment, an EUV light generation control unit 5 includes, in addition to the EUV controller 50, a timer 52 and a memory 53.

3.1 Example of Timer Holding Required Time

The EUV controller 50 is configured to output a measurement start signal for the timer synchronized with the second trigger signal to the timer 52.

The EUV controller 50 is configured to receive an output signal of the timer 52. The EUV controller 50 is configured to output the third trigger signal based on the output signal of the timer 52.

The timer 52 is configured to receive the measurement start signal for the timer from the EUV controller 50. The timer 52 is configured to measure time after receiving the measurement start signal for the timer.

When the timer 52 finishes measurement of a predetermined time, the timer 52 outputs an output signal indicating the finish of the measurement to the EUV controller 50. The predetermined time corresponds to a required time before the ions generated by the irradiation with the second pre-pulse laser beam P2 are eliminated. The required time is, for example, 100 ns to 300 ns.

When the EUV controller 50 receives the output signal indicating the finish of the measurement from the timer 52, the EUV controller 50 outputs the third trigger signal.

3.2 Example of Memory Holding Required Time

The timer 52 may output, as necessary, an output signal indicating time after receiving the measurement start signal for the timer to the EUV controller 50 rather than measuring the predetermined time.

In that case, the EUV controller 50 previously reads, from the memory 53, data on the required time before the ions generated by the irradiation with the second pre-pulse laser beam P2 are eliminated. The required time is, for example, 100 ns to 300 ns. The memory 53 may hold, for example, a plurality of values according to required values of energy of the EUV light as the data on the required time. The EUV controller 50 compares the time after the start of the measurement received from the timer 52 with the required time read from the memory 53. The EUV controller 50 outputs the third trigger signal when the time after the start of the measurement received from the timer 52 reaches the required time read from the memory 53. The memory 53 corresponds to a memory unit in the present disclosure.

3.3 Others

With the above configuration, the target is irradiated with the main pulse laser beam M after the ions generated by the irradiation with the second pre-pulse laser beam P2 are eliminated. “The ions being eliminated” means that the ions are eliminated from at least the optical path of the main pulse laser beam M, and the ions may be present outside the optical path of the main pulse laser beam M.

In other words, the main pulse laser beam M is applied to the neutral particles that remain after the ions of elements constituting the target are eliminated.

Further in other words, the main pulse laser beam M is controlled so as to be applied to a part of the target but not applied to the ions of the elements constituting the target.

Alternatively, the main pulse laser beam M is applied to the target with the ion density of 10¹⁶ atoms/cm³ or lower.

Other points may be the same as the comparative example.

According to the first embodiment, the required time before the ions generated by the irradiation with the second pre-pulse laser beam P2 are eliminated can be precisely measured to apply the main pulse laser beam M to the target 27. This can improve the CE. It is not always necessary to check whether or not the ions have been eliminated in each case, but the required time may be previously calculated by an experiment.

### 4. EUV Light Generation System Including Ion Detector

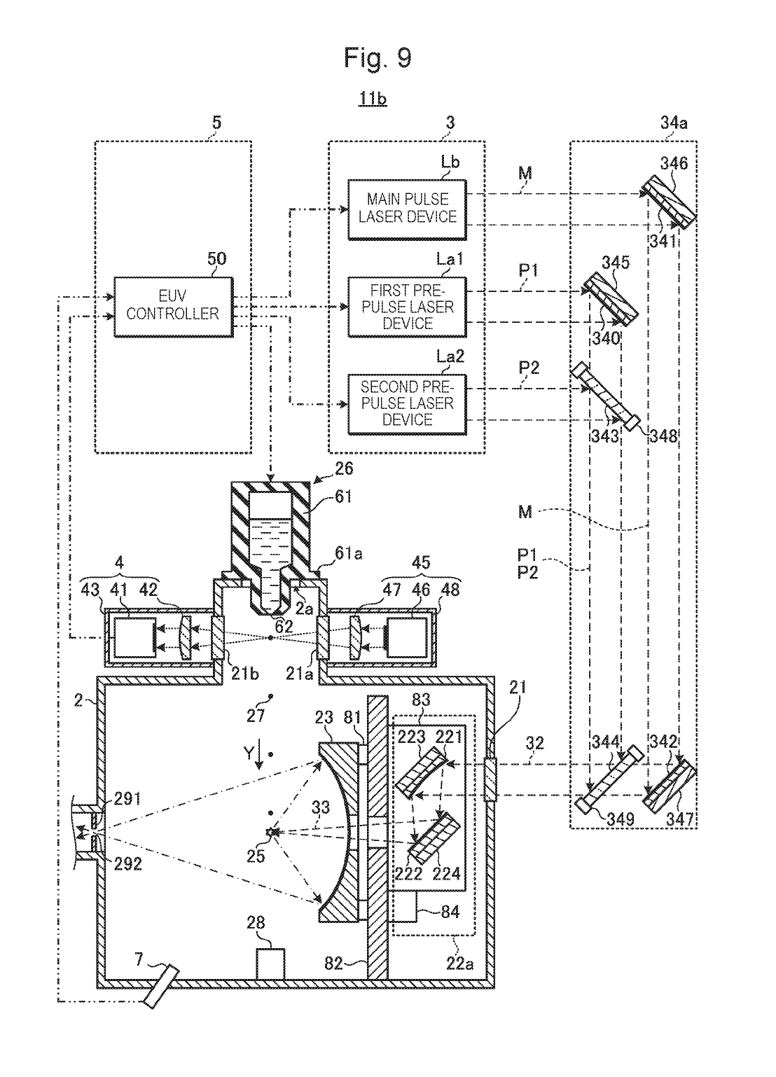

FIG. 9 schematically shows an EUV light generation system 11b according to a second embodiment of the present disclosure. In the second embodiment, an ion detector 7 is mounted to the chamber 2.

4.1 Example of Continuous Monitoring of Presence of Ions

The ion detector 7 includes an optical sensor (not shown) and optics (not shown). The optical sensor is constituted by, for example, a photodiode. The optics is configured to focus light near the plasma generation region 25 on the photodiode.

When light emitted from the ions generated by the irradiation with the second pre-pulse laser beam P2 enters the photodiode, an electromotive force is produced in the photodiode and a current flows. The current is output as an ion detection signal to the EUV controller 50.

Alternatively, the ion detector 7 may include an ion collector arranged near the plasma generation region 25. The ion collector includes a grid electrode (not shown) and a cathode electrode (not shown). The grid electrode is spaced apart from the cathode electrode between the plasma generation region 25 and the cathode electrode. A negative potential is applied to the grid electrode. A buffer circuit (not shown) is connected to the cathode electrode. When the ions pass through the grid electrode and reach the cathode electrode, the potential of the cathode electrode increases, and a current flows through the buffer circuit. The current is output as an ion detection signal to the EUV controller 50.

The EUV controller 50 outputs the second trigger signal to the second pre-pulse laser device La1 and then monitors the ion detection signal from the ion detector 7. The EUV controller 50 sets a time interval between the second trigger signal and the third trigger signal so as to output the third trigger signal after the ion detector 7 no longer detects ions.

4.2 Example of Determination of Presence of Ions at Specific Timing

Alternatively, the ion detector 7 may include a camera (not shown) that captures an image of an emission source near the plasma generation region 25. The camera includes a high speed shutter. The high speed shutter is controlled by the EUV controller 50 so as to open/close at predetermined timing after the EUV controller 50 outputs the second trigger signal.

The EUV controller 50 opens/closes the high speed shutter of the camera, for example, when 100 ns has elapsed since the output of the second trigger signal. The EUV controller 50 outputs the third trigger signal after opening/closing the high speed shutter. The EUV controller 50 measures brightness of a predetermined portion of the image captured by the camera.

When the brightness does not exceed a predetermined value, the EUV controller 50 determines that the ions are eliminated, and maintains opening/closing timing of the high speed shutter and output timing of the third trigger signal.

When the brightness exceeds the predetermined value, the EUV controller 50 determines that the ions are not eliminated, and changes the opening/closing timing of the high speed shutter, for example, from 100 ns mentioned above to 110 ns. The EUV controller 50 also changes the output timing of the third trigger signal according to the change of the opening/closing timing of the high speed shutter.

4.3 Others

With the above configuration, the target is irradiated with the main pulse laser beam M after the ions generated by the irradiation with the second pre-pulse laser beam P2 are eliminated. “The ions being eliminated” means that the ions are eliminated from at least the optical path of the main pulse laser beam M, and the ions may be present outside the optical path of the main pulse laser beam M.

In other words, the main pulse laser beam M is applied to the neutral particles that remain after the ions of elements constituting the target are eliminated.

Further in other words, the main pulse laser beam M is controlled so as to be applied to a part of the target but not applied to the ions of the elements constituting the target.

Alternatively, the main pulse laser beam M is applied to the target with the ion density of 10¹⁶ atoms/cm³ or lower.

Other points may be the same as the comparative example.

According to the second embodiment, whether or not the ions are eliminated can be determined to apply the main pulse laser beam M to the target 27 at appropriate timing. This can improve the CE. It is not always necessary to previously calculate the required time before the ions are eliminated, but changes in operating conditions such as the required value of the energy of the EUV light or the value of the fluence of the second pre-pulse laser beam P2 can be flexibly accommodated.

### 5. Supplementation

The above descriptions are intended to be illustrative only and not restrictive. Thus, it will be apparent to those skilled in the art that modifications may be made in the embodiments of the present disclosure without departing from the scope of the appended claims.

The terms used throughout the specification and the appended claims should be interpreted as “non-limiting.” For example, the term “comprising” or “comprised” should be interpreted as “not limited to what has been described as being comprised.” The term “having” should be interpreted as “not limited to what has been described as having”. Further, the modifier “a/an” described in the specification and the appended claims should be interpreted to mean “at least one” or “one or more”.

What is claimed is:

1. An extreme ultraviolet light generation apparatus comprising:
a target supply unit configured to output a target toward a predetermined region;
a laser system configured to output a first laser beam to be applied to the target, a second laser beam to be applied to the target irradiated with the first laser beam, and a third laser beam to be applied to the target irradiated with the second laser beam; and
a control unit configured to control the laser system such that the third laser beam is applied to the target after ions of elements constituting the target are eliminated from at least an optical path of the third laser beam.

2. The extreme ultraviolet light generation apparatus according to claim 1, wherein the control unit further includes a timer configured to measure time after the control unit outputs a trigger signal to the laser system to output the second laser beam, and controls the laser system based on an output of the timer.

3. The extreme ultraviolet light generation apparatus according to claim 2, further comprising a memory unit configured to hold data on required time after the second laser beam is applied to the target and before the ions of the elements constituting the target are eliminated from the optical path of the third laser beam,
wherein the control unit controls the laser system based on a result of comparison between the required time held in the memory unit and the output of the timer.

4. The extreme ultraviolet light generation apparatus according to claim 3, wherein the required time is 100 ns to 300 ns.

5. The extreme ultraviolet light generation apparatus according to claim 1, further comprising an ion detector configured to detect the ions of the elements constituting the target,
wherein the control unit controls the laser system based on an output of the ion detector.

6. The extreme ultraviolet light generation apparatus according to claim 5, wherein the control unit controls the laser system such that the third laser beam is applied to the target after ions are no longer detected by the ion detector.

7. An extreme ultraviolet light generation apparatus comprising:
a target supply unit configured to output a target toward a predetermined region;
a laser system configured to output a first laser beam to be applied to the target, a second laser beam to be applied to the target irradiated with the first laser beam, and a third laser beam to be applied to the target irradiated with the second laser beam; and
a control unit configured to control the laser system such that the third laser beam is applied to neutral particles that remain after ions of elements constituting the target are eliminated.

8. The extreme ultraviolet light generation apparatus according to claim 7, wherein the control unit further includes a timer configured to measure time after the control unit outputs a trigger signal to the laser system to output the second laser beam, and controls the laser system based on an output of the timer.

9. The extreme ultraviolet light generation apparatus according to claim 8, further comprising a memory unit configured to hold data on required time after the second laser beam is applied to the target and before the ions of the elements constituting the target are eliminated from the optical path of the third laser beam,
wherein the control unit controls the laser system based on a result of comparison between the required time held in the memory unit and the output of the timer.

10. The extreme ultraviolet light generation apparatus according to claim 9, wherein the required time is 100 ns to 300 ns.

11. The extreme ultraviolet light generation apparatus according to claim 7, further comprising an ion detector configured to detect the ions of the elements constituting the target,
wherein the control unit controls the laser system based on an output of the ion detector.

12. The extreme ultraviolet light generation apparatus according to claim 11, wherein the control unit controls the laser system such that the third laser beam is applied to the target after ions are no longer detected by the ion detector.

13. An extreme ultraviolet light generation apparatus comprising:
a target supply unit configured to output a target toward a predetermined region;
a laser system configured to output a first laser beam to be applied to the target, a second laser beam to be applied to the target irradiated with the first laser beam, and a third laser beam to be applied to the target irradiated with the second laser beam; and
a control unit configured to control the laser system such that the third laser beam is applied to a part of the target but is not applied to ions of elements constituting the target.

14. The extreme ultraviolet light generation apparatus according to claim 13, wherein the control unit further includes a timer configured to measure time after the control unit outputs a trigger signal to the laser system to output the second laser beam, and controls the laser system based on an output of the timer.

15. The extreme ultraviolet light generation apparatus according to claim 14, further comprising a memory unit configured to hold data on required time after the second laser beam is applied to the target and before the ions of the elements constituting the target are eliminated from the optical path of the third laser beam,
wherein the control unit controls the laser system based on a result of comparison between the required time held in the memory unit and the output of the timer.

16. The extreme ultraviolet light generation apparatus according to claim 15, wherein the required time is 100 ns to 300 ns.

17. The extreme ultraviolet light generation apparatus according to claim 13, further comprising an ion detector configured to detect the ions of the elements constituting the target,
wherein the control unit controls the laser system based on an output of the ion detector.

18. The extreme ultraviolet light generation apparatus according to claim 17, wherein the control unit controls the laser system such that the third laser beam is applied to the target after ions are no longer detected by the ion detector.
